(19) United States
(12) Patent Application Publication
(10) Pub. No.: US 2017/0358006 A1
(43) Pub. Date: Dec. 14, 2017

(54) METHODS AND SYSTEMS FOR PROCESSING AND DISPLAYING REVIEW DATA BASED ON ONE OR MORE STORED RELATIONSHIP ASSOCIATIONS AND ONE OR MORE RULE SETS

(71) Applicant: ALIBABA GROUP HOLDING LIMITED, George Town (KY)

(72) Inventors: Sheng LI, Hangzhou (CN); Pengjun XIE, Hangzhou (CN); Changlong SUN, Hangzhou (CN); Jun LANG, Hangzhou (CN)

(73) Assignee: ALIBABA GROUP HOLDING LIMITED

(21) Appl. No.: 15/621,664

(22) Filed: Jun. 13, 2017

(30) Foreign Application Priority Data
Jun. 13, 2016 (CN) 201610420789.5

(51) Int. Cl. G06Q 30/02; G06F 17/30; G06Q 50/00

(52) U.S. Cl. CPC G06Q 30/0271; G06Q 30/0201; G06F 17/30035; G06Q 50/01

(57) ABSTRACT

Embodiments of the present disclosure provide methods and systems for processing and displaying online review data of products. In one implementation, a method for processing and displaying online review data may include: acquiring the review data of a target object in accordance with an access trigger instruction of a target user; determining whether an association relationship exists between the target user and a user corresponding to the review data in a pre-established multidimensional user relationship table; in response to the association relationship existing, acquiring the association relationship; and displaying an identifier of the association relationship. Embodiments consistent with the present disclosure optimize the display of review data of a target object, which can help a user better understand the target object, thereby improving the credibility of the review data of the target object and improving user experience.

### CROSS-REFERENCE TO RELATED DISCLOSURE

This disclosure claims priority to and benefits of Chinese Patent Disclosure Serial No. 201610420789.5, filed with the State Intellectual Property Office of P. R. China on Jun. 13, 2016, which is incorporated herein by reference in its entirety.

### TECHNICAL FIELD

The present disclosure relates to the technical field of data processing, and more particularly to methods and systems for processing online review data.

### BACKGROUND

People are increasingly looking into online reviews or comments to determine the quality or obtain information of a product. Providing and maintaining a good online review environment to improve or ensure the credibility of the reviews have become increasingly important.

Currently, online reviews or comments include a large amount of review spam, such as advertisements, repetitive review, and fake, untruthful, or deceptive reviews, resulting in a lack of credibility of the reviews. Some current methods address the review spam by sorting or organizing the reviews through review spam detection and comment folding. Review spam detection methods mainly detect and filter advertisement spam, pornographic spam, political spam, etc. Comment folding methods mainly fold, collapse, or hide repeated or similar reviews, fake reviews, and malicious or disparaging reviews. These current methods can improve the online review environment to some extent. However, the review spam detection methods and comment folding methods are both based on the text information in the review data. Since users generally make anonymous reviews, user information in the review data is not used or referenced in these methods, which only use and display the text content of the reviews. This results in a relatively small amount of information presented to a target user looking into a product. Therefore, the reviews sorted by the review spam detection and comment folding methods are still not trustworthy to the users and thus do not solve the credibility problem of online reviews.

### SUMMARY

To increase the credibility of product reviews, embodiments of the present disclosure provide methods and systems for processing and/or optimizing online review data. Advantageously, embodiments of the present disclosure can help users better understand a product based on the corresponding review data, thus improving user experience and increasing the conversion rate of the product.

In one aspect, the present disclosure provides a method for processing and displaying review data. The method may include acquiring the review data of a target object in accordance with an access trigger instruction of a target user; determining whether an association relationship exists between the target user and a user corresponding to the review data in a pre-established multidimensional user relationship table; in response to the association relationship existing, acquiring the association relationship; and displaying an identifier of the association relationship.

In another aspect, the present disclosure provides a system for processing and displaying review data. The system may include a review data acquisition module configured to acquire the review data of a target object in accordance with an access trigger instruction of a target user, a determination module configured to determine whether an association relationship exists between the target user and a user corresponding to the review data in a pre-established multidimensional user relationship table, an association relationship acquisition module configured to acquire the association relationship if the association relationship exists, and a display module configured to display an identifier of the association relationship.

In another aspect, the present disclosure provides a non-transitory computer-readable medium that stores a set of instructions that are executable by at least one processor of a server to cause the server to perform a method for processing and displaying review data. The method may include acquiring the review data of a target object in accordance with an access trigger instruction of a target user; determining whether an association relationship exists between the target user and a user corresponding to the review data in a pre-established multidimensional user relationship table; acquiring the association relationship if the association relationship exists; and displaying an identifier of the association relationship.

Additional features and advantages of the disclosed embodiments will be set forth in part in the description that follows, and in part will be obvious from the description, or may be learned by practice of the disclosed embodiments. The features and advantages of the disclosed embodiments will be realized and attained by the elements and combinations particularly pointed out in the appended claims.

It is to be understood that both the foregoing general description and the following detailed description are examples and explanatory only and are not restrictive of the disclosed embodiments as claimed.

The accompanying drawings constitute a part of this specification. The drawings illustrate several embodiments of the present disclosure and, together with the description, serve to explain the principles of the disclosed embodiments as set forth in the accompanying claims.

### BRIEF DESCRIPTION OF THE DRAWINGS

The accompanying drawings constitute a part of this specification. The drawings illustrate several embodiments of the present disclosure and, together with the description, serve to explain the principles of the disclosure.

FIG. 1 is a flow chart of an exemplary method for processing and displaying review data, consistent with embodiments of the present disclosure.

FIG. 2 is a flow chart of an exemplary method for establishing a multidimensional user relationship table, consistent with embodiments of the present disclosure.

FIG. 3 is a schematic diagram illustrating the display of exemplary identifiers of the association relationships between the target user and the users corresponding to the review data, consistent with embodiments of the present disclosure.

FIG. 4 is a schematic block diagram illustrating an exemplary system for processing and displaying review data, consistent with embodiments of the present disclosure.

### DETAILED DESCRIPTION

Reference will now be made in detail to embodiments and aspects of the present disclosure, examples of which are illustrated in the accompanying drawings. Where possible, the same reference numbers will be used throughout the drawings to refer to the same or like parts. The embodiments of the present disclosure provide methods and systems for processing and displaying online review data.

After acquiring review data of a target object in accordance with an access trigger instruction of a target user, embodiments of the present disclosure can determine whether an association relationship between the target user and a user corresponding to the review data exists in a pre-established multidimensional user relationship table. If the association relationship exists in the pre-established multidimensional user relationship table, embodiments of the present disclosure acquire the association relationship, and display an identifier of the association relationship. Advantageously, when a user accesses and browses the review data of the target object, the user not only can acquire comment on the target object in the review data, but also can acquire information about the association relationship between himself or herself and the user corresponding to the review data based on the identifier of the association relationship, which in turn substantially improves the credibility of the review data. Compared with the current methods for filtering spam, the embodiments of the present disclosure can optimize the review data and improve the credibility of the review data, which further help a user better understand the target object.

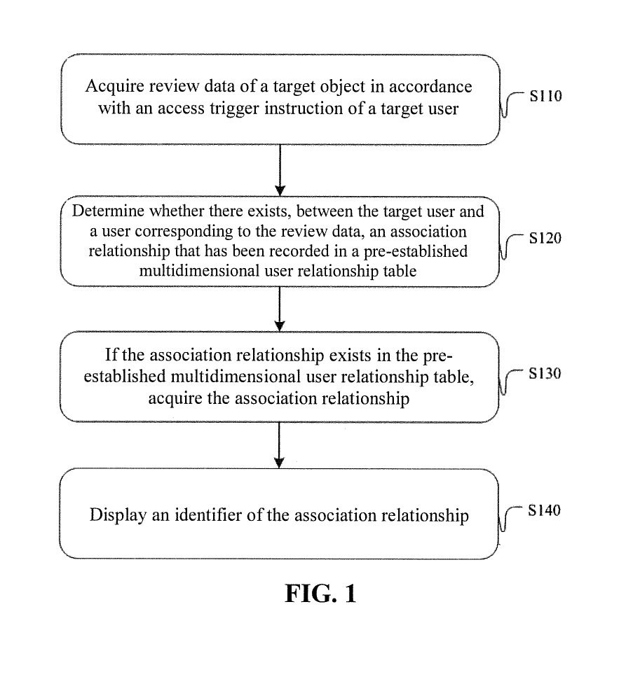

An exemplary method for processing and displaying review data is described below with reference to FIG. 1.

FIG. 1 is a flow chart of an exemplary method for processing and displaying review data, consistent with embodiments of the present disclosure. As shown in FIG. 1, the exemplary method may include steps S110-S140.

Step S110: Acquire review data of a target object in accordance with an access trigger instruction of a target user.

In some embodiments, a server system may acquire the review data of a target object in accordance with an access trigger instruction of a target user. The access trigger instruction of the target user may be an operation of clicking a preset access button when the target user accesses the review data in a review interface of a target object. The target user may be a user who browses and accesses the review data in the review interface. The target object may be a product currently browsed and accessed by the target user on an e-commerce website. The review data may include comments on the target object by other users, the corresponding user identifiers, etc.

For example, assuming that a target user A needs to access the review data in a review interface of a product X (target object). Target user A may click an access button in the e-commerce website that corresponds to the review interface of product X, generating an access trigger instruction. After receiving the access trigger instruction of target user A, a server system may acquire the review data of product X based on the access trigger instruction. If product X is a down jacket, for example, Table 1 shows an example of the review data of product X in the applications of embodiments of the present disclosure.

TABLE 1

| User identifier | Comment |
|---|---|
| User B | The down jacket is very warm, and the express |
| | delivery is very fast. |
| User C | Feathers come out. The quality is unsatisfactory. |
| User D | The style is pretty good. It keeps me warm in |
| | November, good for this season. |

It should be noted that Table 1 only records part of the review data, and illustrates only one form of the review data. The review data as shown in Table 1 is a non-limiting example for the application of the embodiments of the present disclosure.

S120: Determine whether there exists, between the target user and a user corresponding to the review data, an association relationship that has been recorded in a pre-established multidimensional user relationship table.

In the embodiments of the present disclosure, after step S110, the server system may determine whether an association relationship exists between the target user and a user corresponding to the review data. The server system looks up the association relationship in a pre-established multidimensional user relationship table that records a plurality of association relationships between pairs of users. An association relationship may include a textural representation that reflects a connection between a pair of users. In some embodiments, the association relationship between a pair of users may include relationships of multiple dimensions (types), such as difference, similarity, and/or personal connections. In some embodiments of the present disclosure, the existence of an association relationship may be sequentially determined for every two users in the application system.

In some embodiments, the multidimensional user relationship table records association relationships between pairs of users and the corresponding user identifiers. A user identifier may include unique identification information of a user, such as a user name and a user ID. The multidimensional user relationship table may be stored locally in the server system, or may be stored in other storage systems. For example, a distributed key-value storage system may be queried in real time. Table 2 is an example of the multidimensional user relationship table in accordance with the embodiments of the present disclosure.

TABLE 2

| Association relationship | User identifier | User identifier |
|---|---|---|
| Same city and similar figures | User A | User D |
| Friends | User B | User D |
| Same shopping preferences | User A | User C |

As can be seen from Table 2, a user may have one or more dimensions (types) of association relationships with other users. In some instances, a user may have no association relationship with other users in the multidimensional user relationship table. Table 2 only shows the association relationships of some users recorded in the multidimensional user relationship table and the corresponding user identifiers. The number of users, the user identifiers, and the association relationships recorded in the multidimensional user relationship table may be changed or updated. Table 2 only shows one form of the multidimensional user relationship table as a non-limiting example for application of the embodiments of the present disclosure.

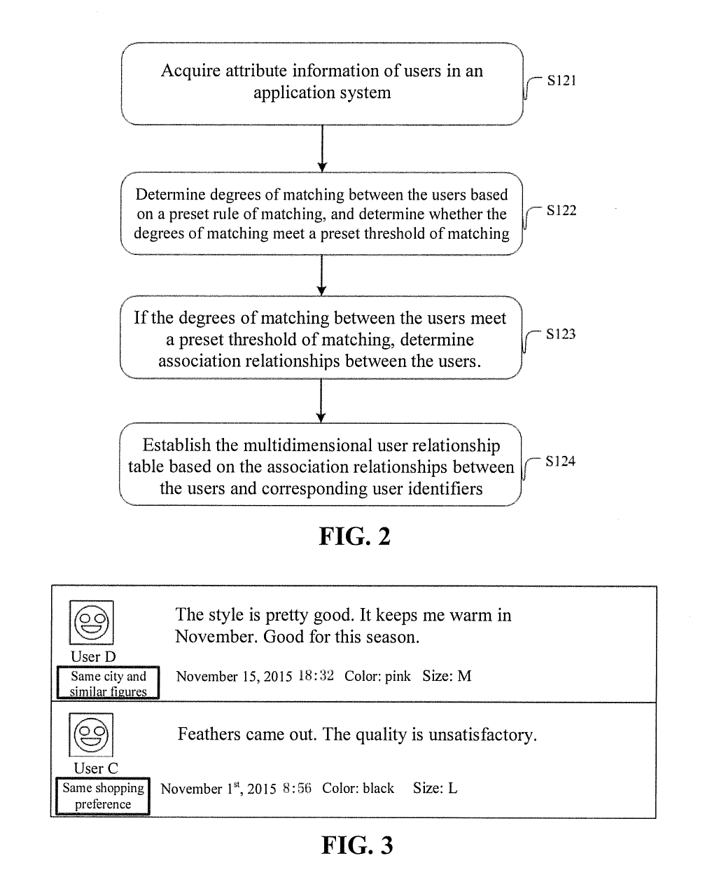

FIG. 2 is a flow chart of an exemplary method for establishing a multidimensional user relationship table, consistent with embodiments of the present disclosure. As shown in FIG. 2, the exemplary method include at least steps S121-S124.

Step S121: Acquire attribute information of users in an application system.

The application system in the embodiments of the present disclosure may include a system that stores user attribute information, and generally includes attribute information of a plurality of users. In some embodiments, the application system and the server system may be integrated into one system or may be separate systems. For example, the application system may be an e-commerce platform.

The attribute information of the users may include at least one of the following: social network connection information of the users, personal information of the users, and behavioral information of the users.

In some embodiments, the social network connection information of the users may include the information of another user that a current user follows, information of another user who follows the current user, and information of another user who follows and is followed by the current user. The personal information of the users may include information such as gender, height, weight, and/or address information. The behavioral information of the users may include online behavioral characteristics of the users.

In addition, it should be noted that the attribute information of the users in the embodiments of the present disclosure is not limited to the social network connection information, the personal information, and the behavioral information of the users as described above, and may include other types of information recorded in the application system.

Step S122: Determine, using the attribute information of the users, degrees of matching between the users based on a preset rule of matching, and determine whether the degrees of matching meet a preset threshold of matching.

In the embodiments of the present disclosure, after the attribute information of the users in the application system is acquired in step S121, using the attribute information of the users, degrees of matching between the users are determined based on a preset rule of matching, and then it is determined whether the degrees of matching meet a preset threshold of matching. The degrees of matching includes a textual representation that can reflect a degree or trend of matching between the attribute information of users, and may also include a particular value that is obtained after the textual representation is quantified based on a preset rule. For example, a textual representation of a degree of matching may be “medium.” In this case, the textual representation “medium” may be quantified to be the binary value or hexadecimal value of the ASCII code of the text “medium.” The preset rule of matching may be applied based on the type of acquired attribute information of the users as described below.

In some embodiments, when the attribute information of the users includes the social network connection information of the users, determining a degree of matching between two users may include: determining a social network association relationship between the two users based on their social network connection information, and determine whether the social network association relationship matches a preset type of social network association relationship.

The types of the social network association relationship or the preset social network association relationship may include any one of the following relationships: a unilateral active-following relationship, a unilateral passive-following relationship, and a mutual following relationship. Thus, the preset rule of matching may be set based on the particular social network association relationship between the users.

For example, the application system includes users A, B, C, D, E, F, G, H, I, and J. Social network connection information of user A include: user B who is followed by the user A, user C who follows user A, and users D and I who follow and are also followed by user A. Therefore, the social network association relationships between user A and users A, B, C, D, E, F, G, H, I, and J in the application system can therefore be determined respectively. Then, it can be determined that the social network association relationships between user A and users B, C, D, and I, match the preset types of social network association relationships, and that the social network association relationships between user A and users E, F, G, H, and J do not match the preset types social network association relationships. In this way, it can be determined that the degrees of matching between user A and users B, C, D, and I meet the preset threshold of matching while the degrees of matching between user A and users E, F, G, H, and J do not meet the preset threshold of matching.

In some embodiments, when the attribute information of the users includes the personal information of the users, determining, using the attribute information of the users, degrees of matching between the users based on a preset rule of matching, and determining whether the degrees of matching meet a preset threshold of matching may further include: determining degrees of difference between the personal information of the users in the application system using the personal information of the users, and determining whether the degrees of difference are within a preset range of degree of difference.

The degrees of difference may include a textual representation that can reflect a degree or trend of difference between the users, and may also include a particular value that is obtained after the textual representation is quantified based on a preset rule. For example, a textual representation of a degree of difference may be “medium.” In this case, the textual representation “medium” may be quantified to be the binary value or hexadecimal value of the ASCII code of “medium.” In this way, the preset rule of matching may be set based on the personal information of users for determining the degrees of matching between the users.

For example, when height and weight are used as the personal information, the preset range for height difference may be from −2 cm to +2 cm (including −2 cm and +2 cm), and the preset range for weight difference may be from −3 kg to +3 kg (including −3 kg and +3 kg). If the personal information of a user A includes a height of 163 cm and a weight of 50 kg, the personal information of a user B includes a height of 164 cm and a weight of 51.5 kg, and the personal information of a user C includes a height of 170 cm and a weight of 53 kg, it can be determined that a degree of difference between user A and user B may include a height difference of +1 cm and a weight difference of +1.5 kg, and a degree of difference between user A and user C may include a height difference of +7 cm and a weight difference of +3 kg. Then, it can be determined that the degree of difference between user A and user B is in the preset range of degree of difference, and the degree of difference between user A and user C is not in the preset range of degree of difference. In this way, it can be determined that the degree of matching between user A and user B meets the preset threshold of matching while the degree of matching between user A and user C does not meet the preset threshold of matching.

In addition, it should be noted that the preset range of degree of difference is not limited to the examples described above, and may further include other definitions for the same or different types of personal information. For example, when the personal information includes address information, the preset range of degree of difference may be defined as a range of distance between addresses. The specific types of personal information described herein are non-limiting examples for the application of the embodiments of the present disclosure.

In some embodiments, when the attribute information of the users includes the behavioral information of the users, determining, using the attribute information of the users, degrees of matching between the users based on a preset rule of matching, and determining whether the degrees of matching meet a preset threshold of matching further includes: determining degrees of similarity between the behavioral information of the users in the application system using the behavioral information of the users, and determining whether the degrees of similarity are within a preset range of degree of similarity.

The degree of similarity may include a textual representation that can reflect a degree or trend of similarity between the online shopping behaviors of the users, and may also include a particular value which is obtained after the textual representation is quantified based on a preset rule. For example, a textual representation of a degree of similarity may be “medium.” In this case, the textual representation “medium” may be quantified to be the binary value or hexadecimal value of the ASCII code of “medium.” In this way, the preset rule of matching may be set based on the behavioral information of users for determining the degree of similarity.

For example, the behavioral information of a user may include the online purchasing behavior of the user. The preset range of degree of similarity is that products or services accounting for the highest proportion of purchases are in the same category and that products or services accounting for the three highest proportions of purchases are in the same categories. Among products or services purchased by a user A, for example, clothing, snacks, and skin care products account for 80% (where clothing accounts for 50%, snacks account for 20%, and skin care products account for 10%), digital products account for 10%, and transportation service accounts for 10%. Among products or services purchased by a user B, clothing, snacks, and skin care products account for 85% (where clothing accounts for 45%, snacks account for 30%, and skin products account for 10%), transportation service accounts for 10%, and digital products account for 5%. Among products or services purchased by a user C, digital products, transportation, and skin care products account for 85% (where digital products account for 50%, transportation accounts for 25%, and skin care products account for 10%), clothing accounts for 10%, and snacks account for 5%. Then, it can be determined that, for both user A and user B, the category of clothing accounts for the highest proportion of purchases, and for both user A and user B, the categories of the products or services accounting for the three highest proportions of their purchases are clothing, snacks, and skin care products. Thus, in this instance, it can be determined that a degree of similarity between user A and user B is within the preset range of degree of similarity. On the other hand, while clothing accounts for the highest proportion of purchases of user A, digital products account for the highest proportion of purchases of user C, and the categories of the products or services accounting for the three highest proportions of the purchases of user A are different from those of user C. Thus, it can be determined that a degree of similarity between user A and user C is not in the preset range of degree of similarity. In this way, it can be determined that the degree of matching between user A and user B meets the preset threshold of matching while the degree of matching between user A and user C does not meet the preset threshold of matching.

In addition, it should be noted that the preset range of degree of similarity is not limited to the above example. Other parameters may be further included to define the preset range of degree of similarity. For example, the preset range of degree of similarity may be defined as: products or services accounting for the highest proportion of purchases are in the same category and this category accounts for 50% or higher of the total purchases. These definitions used to preset the range of degree of similarity are non-limiting examples for the application of the embodiments of the present disclosure.

Step S123: Upon determining that the degrees of matching between the users meet a preset threshold of matching, determine association relationships between the users.

When the attribute information of the users includes the social network connection information of the users as described above, and when step S122 determines that the degrees of matching between the users meet the preset threshold of matching, step S123 determines association relationships between the users whose social network association relationships meet the preset type of social network association relationship. In some instances, the association relationships between the users whose social network association relationship meet the preset type of social network association relationship may be determined as “friends” or other categories.

When the attribute information of the users includes the personal information of the users as described above, and when step S122 determines that the degrees of matching between the users meet the preset threshold of matching, step S123 determines association relationships between the users whose degrees of difference are in the preset range of degree of difference. In some instances, the association relationships between the users whose degrees of difference are in the preset range of degree of difference may be determined as “same city,” “same neighborhood,” “similar figures,” “close in age,” “same shopping preference,” “friends” or “Taobao friends,” or other categories. “Similar figures,” for example, may refer to the association relationship between users who have a height difference of less than about 2 cm and a weight difference of less than about 5 kg. The association relationship of “same city” or “same neighborhood” may be determined based on the address information of the personal information of the users. The association relationship of “same shopping preference” may be determined based on the online shopping history of the users. The association relationship of “friends” or “Taobao friends” may be determined if the users follow or befriended with each other in a social network or online community, such as Taobao or other online shopping platforms.

When the attribute information of the users includes the behavioral information of the users, and when step S122 determines that the degrees of matching between the users meet the preset threshold of matching, step S123 determines association relationships between the users whose degree of similarity is in the preset range of degree of similarity. In some instances, the association relationships between the users whose degrees of similarity are in the preset range of degree of similarity may be determined as “with same shopping preference,” or other categories.

Step S124: Establish the multidimensional user relationship table based on the association relationships between the users and corresponding user identifiers.

After the association relationships between the users are determined, the multidimensional user relationship table may be established based on the association relationships between the users and corresponding user identifiers.

Step S130 of FIG. 1: After determining that an association relationship between the target user and a user corresponding to the review data exists in the pre-established multidimensional user relationship table, acquire the association relationship.

When a target user A accesses the review data in the review interface of the product X (target object), assuming that Table 2 is a pre-established multidimensional user relationship table, it can be seen, with reference to the review data of the product X in Table 1, that users having association relationships with target user A include user C and user D. The association relationship between target user A and user C is “same shopping preference,” and the association relationship between target user A and user D is “same city and similar figures.”

Step S140: Display an identifier of the association relationship between the target user and the user corresponding to the review data.

In the embodiments of the present disclosure, the server system may display the identifier of the association relationship between the target user and the user corresponding to the review data, which may further include: displaying, in a preset display area for displaying the review data, the identifier of the association relationship between the target user and the user corresponding to the review data.

The identifier of the association relationship may include a type of identifier that can reflect the association relationship, and the association relationship and the identifier of the association relationship may be the same or different. For example, the association relationship between user A and user B is “friends,” and the identifier of the association relationship may be “friends” or may be “following each other” that can reflect the association relationship “friends.” The preset display area may be any subarea within the area for displaying review data in the review interface of the target object. In such instances, when browsing the review data, the target user can acquire information about the association relationship between himself or herself and the user corresponding to the review data from the identifier of the association relationship displayed in the preset display area. This substantially increases the credibility of the review data to the target user, which can help the target user better understand the target object and make an informed purchasing decision.

For example, as shown in Table 3, when target user A accesses the review data in the review interface of the product X, an identifier of the association relationship between target user A and user C corresponding to user C's review data may be displayed as “same shopping preference,” and an identifier of the association relationship between target user A and user D corresponding to user D's review data may be displayed as “same city and similar figures.”

TABLE 3

| User | Identifier of Association | |
|---|---|---|
| identifier | relationship | Comment |
| User D | Same city and similar | The style is pretty good. It keeps |
| | figures | me warm in November, good for |
| | | this season. |
| User C | Same shopping | Feathers come out. The quality |
| | preferences | is unsatisfactory. |

In addition, it should be noted that Table 3 only records some of the review data that includes identifiers of association relationships, and that Table 3 only shows one form of recording the review data. The form of recording the review data as shown in Table 3 is a non-limiting example for the application of the embodiments of the present disclosure.

FIG. 3 is a schematic diagram illustrating the display of exemplary identifiers of the association relationships recorded in Table 3 in a preset display area for displaying the review data. As shown in FIG. 3, when browsing review data, target user A not only can view comments on the product (e.g., a down jacket) in the review data, but also can view the identifiers of the association relationships between target user A and users who have purchased and commented on the product. This substantially improves the credibility of the review data, and helps target user A better understand the product, thereby improving user experience. As shown in FIG. 3, the preset display area may include additional information, such as the users' profile pictures, the time points the comments were made, and the colors and sizes of the products purchased.

In some embodiments, the identifiers of the association relationships may be displayed adjacent the profile pictures of the users who previously provided comments on the product in an emphatic form, such as in a text box below the profile pictures. For example, the identifiers of the association relationships may be displayed below the profile pictures of the users who previously provided comments on the product, allowing the user to quickly assess the credibility or applicability of the review or comment. On the other hand, if an association relationship between the target user A and a user who previously provided comment on the product does not exist in the pre-established multidimensional user relationship table, no identifier is displayed.

In some embodiments, the exemplary method for processing and displaying review data may further include: prioritizing or sorting the display of review data associated with the identifiers of the association relationships in the review interface for displaying the review data of the target object.

Considering that a user generally first view review data placed at the top of a review interface, the server system may prioritize or sort the display of some entries of review data that are associated with identifiers of association relationships in the review interface for displaying the review data of the target object. In this way, the target user can quickly acquire the review data with higher credibility or applicability and quickly understand the target object, which improves user experience. For example, the comment of a first user whose association relationship with the target user A are “friends” and “close in age” is displayed before the comment of a second user whose association relationship with the target user A is “same city” in the review interface. In such instances, the identifiers of the association relationships between the target user A and these users may be displayed below their respective profile pictures, for example. Additionally, the comments of the users whose association relationships with the target user A do not exist in the pre-established multidimensional user relationship table may be displayed after the comments of the users whose association relationships with the target user A exist.

As described above, after acquiring review data of a target object in accordance with an access trigger instruction of a target user, the exemplary methods consistent with the present disclosure can determine, based on a pre-established multidimensional user relationship table, whether an association relationship between the target user and a user corresponding to the review data exists. And if the association relationship exists in the pre-established multidimensional user relationship table, the exemplary methods consistent with the present disclosure acquire the association relationship, and displays an identifier of the association relationship in the review interface of the target object. Therefore, when a target user accesses and browses the review data of the target object, the user not only can acquire comment data in the review data, but also can acquire the association relationship between the target user and the user corresponding to the review data (e.g., the user who made the comment) via the identifier of the association relationship, which substantially improves the credibility of the review data. Compared with the current methods for filtering spam in review data, the technical solutions provided by the embodiments of the present disclosure can optimize the use of the review data and improve the credibility of the review data, which in turn helps a user better understand the target object. Advantageously, embodiments of the present disclosure can help online users better understand a product based on its review data, and thus improve user experience and further increase the conversion rate of the product.

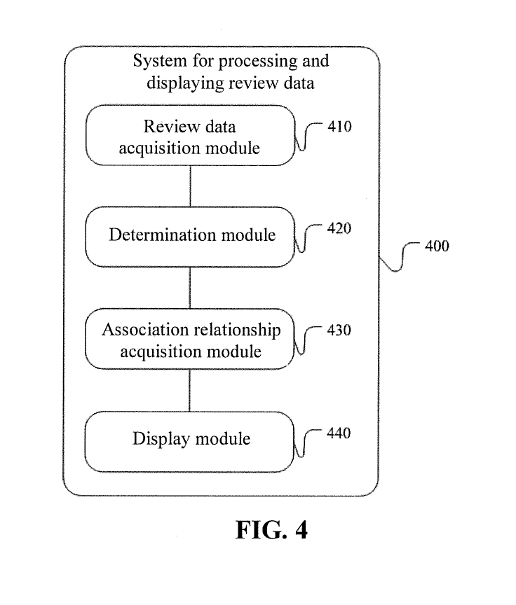

In another aspect, the present disclosure further provides a system for processing and displaying review data. FIG. 4 is a schematic block diagram illustrating an exemplary system 400 for processing and displaying review data, consistent with embodiments of the present disclosure. As shown in FIG. 4, system 400 may include: a review data acquisition module 410, a determination module 420, an association relationship acquisition module 430, and a display module 440.

The review data acquisition module 410 is configured to acquire review data of a target object in accordance with an access trigger instruction of a target user.

The determination module 420 is configured to determine whether there exists, between the target user and a user corresponding to the review data, an association relationship that is recorded in a pre-established multidimensional user relationship table.

The association relationship acquisition module 430 is configured to acquire the association relationship between the target user and the user corresponding to the review data if the association relationship exists.

The display module 440 is configured to display an identifier of the association relationship.

In some embodiments, the display module 440 may include: a display unit. The display unit is configured to display, in a preset display area for displaying the review data, the identifier of the association relationship between the target user and the user corresponding to the review data.

In some embodiments, system 400 may further include: a display processing module (not shown). The display processing module is configured to prioritize the display of the review data associated with the identifiers of the association relationships in the review interface for displaying the review data of the target object.

In some embodiments, the multidimensional user relationship table may be established by using the following units (not shown): an attribute information acquisition unit, a data processing unit, an association relationship determining unit, and a table establishment unit.

The attribute information acquisition unit is configured to acquire attribute information of users in an application system.

The data processing unit is configured to determine, using the attribute information of the users, degrees of matching between the users based on a preset rule of matching, and determine whether the degrees of matching meet a preset threshold of matching.

The association relationship determining unit is configured to determine, when the degrees of matching between the users meet a preset threshold of matching, association relationships between these users.

The table establishment unit is configured to establish the multidimensional user relationship table based on the determined association relationships between the users and corresponding user identifiers.

In some embodiments, the attribute information of users may include at least one of the following: social network connection information, personal information, and behavioral information of the users.

In some embodiments, the data processing unit may further include: a first data processing unit, a second data processing unit, and/or a third data processing unit (not shown).

In some embodiments, the association relationship determining unit may further include a first association relationship determining unit, a second association relationship determining unit, and/or a third association relationship determining unit (not shown).

The first data processing unit is configured to determine social network association relationships between the users based on the social network connection information of the users, and determine whether the social network association relationships match a preset type of social network association relationship.

If the first data processing unit determines that the social network association relationships of the users match a preset type of social network association relationship, the first association relationship determining unit is configured to determine association relationships between the users.

The second data processing unit is configured to determine degrees of difference between the personal information of the users in the application system using the personal information of the users, and determine whether the degrees of difference are in a preset range of degree of difference range.

If the second data processing unit determines that the degrees of difference are in a preset range of degree of difference, the second association relationship determining unit is configured to determine association relationships between the users whose degrees of difference are in the preset range of degree of difference.

The third data processing unit is configured to determine degrees of similarity between the behavioral information of the users in the application system based on the behavioral information of the users, and determine whether the degrees of similarity are in a preset range of degree of similarity.

If the third data processing unit determines that the degrees of similarity are in a preset range of degree of similarity, the third association relationship determining unit is configured to determine association relationships between the users whose degrees of similarity are in the preset degree of similarity range.

As describe herein, after acquiring review data of a target object in accordance with an access trigger instruction of a target user, the methods and systems consistent with the present disclosure determine, based on a pre-established multidimensional user relationship table, whether there exists an association relationship between the target user and a user corresponding to the review data in the pre-established multidimensional user relationship table. If it is determined that the association relationship exists, embodiments of the methods and systems also acquire the association relationship between the target user and the user corresponding to the review data. Embodiments of the methods and systems further display an identifier of the association relationship between the target user and the user corresponding to the review data. Advantageously, when a user accesses and browses the review data of the target object, the user not only can acquire comment on the target object in the review data, but also can acquire information about the association relationship between himself or herself and the user corresponding to the review data (the user who made the comment) based on the identifier of the association relationship, which substantially increases the credibility of the review data. Compared with the current methods for filtering spam in the review data, the methods and systems consistent with the present disclosure can optimize the review data and improve the credibility of the review data. This in turn can help a user better understand the target product. In some instances, the methods and systems consistent with the present disclosure can help users better understand a product based on the review data, thereby improving user experience and further increasing the conversion rate of the product.

The above-described data query between the server system and the distributed key-value storage system is a non-limiting example for the application of the present disclosure. The disclosed embodiments of the present disclosure are not limited to the above-described examples.

In general, the modules and units can be a packaged functional hardware unit designed for use with other components (e.g., portions of an integrated circuit) or a part of a program (stored on a computer readable medium) that performs a particular function of related functions. The module can have entry and exit points and can be written in a programming language, such as, for example, Java, Lua, C or C++. A software module can be compiled and linked into an executable program, installed in a dynamic link library, or written in an interpreted programming language such as, for example, BASIC, Perl, or Python. It will be appreciated that software modules can be callable from other modules or from themselves, and/or can be invoked in response to detected events or interrupts. Software modules configured for execution on computing devices can be provided on a computer readable medium, such as a compact disc, digital video disc, flash drive, magnetic disc, or any other non-transitory medium, or as a digital download (and can be originally stored in a compressed or installable format that requires installation, decompression, or decryption prior to execution). Such software code can be stored, partially or fully, on a memory device of the executing computing device, for execution by the computing device. Software instructions can be embedding in firmware, such as an EPROM. It will be further appreciated that hardware modules can be comprised of connected logic units, such as gates and flip-flops, and/or can be comprised of programmable units, such as programmable gate arrays or processors. The modules or computing device functionality described herein are preferably implemented as software modules, but can be represented in hardware or firmware. Generally, the modules described herein refer to logical modules that can be combined with other modules or divided into sub-modules despite their physical organization or storage.

The present disclosure may be described in a general context of computer-executable commands or operations, such as a program module, stored on a computer readable medium and executed by a computing device or a computing system, including at least one of a microprocessor, a processor, a central processing unit (CPU), a graphical processing unit (GPU), etc.

The present disclosure may also be implemented in a distributed computing environment, and in these distributed computing environments, tasks or operations may be executed by a remote processing device connected through a communication network, e.g., the Internet. In the distributed computing environment, the program module may be located in a local or a remote non-transitory computer-readable storage medium, including a flash disk or other forms of flash memory, a Read-Only Memory (ROM), a Random Access Memory (RAM), a magnetic disk, an optical disk, a cache, a register, etc.

Furthermore, although aspects of the disclosed embodiments are described as being associated with data and/or instructions stored in a memory and/or other tangible and/or non-transitory computer-readable mediums, it would be appreciated that these data and/or instructions can also be stored on and executed from many types of tangible computer-readable storage medium, such as storage devices, including hard disks, floppy disks, or CD-ROM, or other forms of RAM or ROM. Accordingly, the disclosed embodiments are not limited to the above-described examples, but instead is defined by the appended claims in light of their full scope of equivalents.

Embodiments of the present disclosure may be embodied as a method, a system, a computer program product, etc. Accordingly, embodiments of the present disclosure may take the form of an entirely hardware embodiment, an entirely software embodiment, or an embodiment combining software and hardware for allowing a specialized device having the described specialized components to perform the functions described above. Furthermore, embodiments of the present disclosure may take the form of a computer program product embodied in one or more computer-readable storage media that may be used for storing computer-readable program codes.

Embodiments of the present disclosure are described with reference to flow charts and/or block diagrams of methods, devices (systems), and computer program products. It will be understood that each flow chart and/or block diagram can be implemented by computer program instructions. These computer program instructions may be provided to a processor of a special-purpose computer, an embedded processor, or other programmable data processing devices or systems to produce a machine or a platform, such that the instructions, when executed via the processor of the computer or other programmable data processing devices, implement the functions and/or steps specified in one or more flow charts and/or one or more block diagrams.

The computer-readable storage medium may refer to any type of non-transitory memory on which information or data readable by a processor may be stored. Thus, a computer-readable storage medium may store instructions for execution by one or more processors, including instructions for causing the processor(s) to perform steps or stages consistent with the embodiments described herein. The computer-readable medium includes non-volatile and volatile media, removable and non-removable media. The information and/or data storage can be implemented with any method or technology. Information and/or data may be modules of computer-readable instructions, data structures, and programs, or other types of data. Examples of a computer-readable storage medium include, but are not limited to, a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a cache, a register, a compact disc read-only memory (CD-ROM), a digital versatile disc (DVD) or other optical storage, a cassette tape, tape or disk storage, or other magnetic storage devices, or any other non-transitory media that may be used to store information capable of being accessed by a computer device.

It should be noted that, the relational terms such as “first” and “second” are only used to distinguish an entity or operation from another entity or operation, and do necessarily require or imply that any such actual relationship or order exists among these entities or operations. It should be further noted that, as used in this specification and the appended claims, the singular forms “a,” “an,” and “the,” and any singular use of any word, include plural referents unless expressly and unequivocally limited to one referent. As used herein, the terms “include,” “comprise,” and their grammatical variants are intended to be non-limiting, such that recitation of items in a list is not to the exclusion of other like items that can be substituted or added to the listed items.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as example only, with a true scope and spirit being indicated by the following claims and their full scope of equivalents.

This description and the accompanying drawings that illustrate exemplary embodiments should not be taken as limiting. Various mechanical, compositional, structural, electrical, and operational changes may be made without departing from the scope of this description and the claims, including equivalents. In some instances, well-known structures and techniques have not been shown or described in detail so as not to obscure the disclosure. Similar reference numbers in two or more figures represent the same or similar elements. Furthermore, elements and their associated features that are disclosed in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A method for processing and displaying review data, comprising:
acquiring the review data of a target object in accordance with an access trigger instruction of a target user;
determining whether an association relationship exists between the target user and a user corresponding to the review data in a pre-established multidimensional user relationship table;
in response to the association relationship existing, acquiring the association relationship; and
displaying an identifier of the association relationship.

2. The method of claim 1, wherein displaying the identifier of the association relationship comprises:
displaying, in a preset display area for displaying the review data, the identifier of the association relationship between the target user and the user corresponding to the review data.

3. The method of claim 1, further comprising:
prioritizing the display of review data associated with the identifier of the association relationship in a review interface for displaying the review data of the target object.

4. The method of claim 1, wherein the multidimensional user relationship table is established by:
acquiring attribute information of users in an application system;
determining association relationships between the users whose degrees of matching meet a preset threshold of matching; and
establishing the multidimensional user relationship table based on the association relationships between the users and corresponding user identifiers.

5. The method of claim 4, wherein the degrees of matching between the users are determined based on the attribute information of the users and a preset rule of matching.

6. The method of claim 4, wherein, the attribute information of the users comprises the social network connection information of the users, and whether the users' degrees of matching meet a preset threshold of matching is determined based on the social network connection information of the users.

7. The method of claim 4, wherein, the attribute information of the users comprises the personal information of the users, and whether the users' degrees of matching meet a preset threshold of matching is determined based on the personal information of the users.

8. The method of claim 4, wherein, the attribute information of the users comprises the behavioral information of the users, and whether the users' degrees of matching meet a preset threshold of matching is determined based on the behavioral information of the users.

9. A system for processing and displaying review data, comprising:
a review data acquisition module configured to acquire the review data of a target object in accordance with an access trigger instruction of a target user;
a determination module configured to determine whether an association relationship exists between the target user and a user corresponding to the review data in a pre-established multidimensional user relationship table;
an association relationship acquisition module configured to acquire the association relationship if the association relationship exists; and
a display module configured to display an identifier of the association relationship.

10. The system of claim 9, wherein the display module comprises:
a display unit configured to display, in a preset display area for displaying the review data, the identifier of the association relationship.

11. The system of claim 9, further comprising:
a display processing module configured to prioritize the display of review data associated with the identifier of the association relationship in a review interface for displaying the review data of the target object.

12. The system of claim 9, wherein the multidimensional user relationship table is established by using the following units:
an attribute information acquisition unit configured to acquire attribute information of users in an application system;
an association relationship determining unit configured to determine association relationships between the users whose degrees of matching meet the preset threshold of matching; and
a table establishment unit configured to establish the multidimensional user relationship table based on the association relationships between the users and corresponding user identifiers.

13. The system of claim 12, further comprising a data processing unit configured to determine the degrees of matching between the users based the attribute information of the users and a preset rule of matching.

14. The system of claim 12, wherein the attribute information of the users comprises the social network connection information of the users, and whether the users' degrees of matching meet a preset threshold of matching is determined based on the social network connection information of the users.

15. The system of claim 12, wherein, the attribute information of the users comprises the personal information of the users, and whether the users' degrees of matching meet a preset threshold of matching is determined based on the personal information of the users.

16. The system of claim 12, wherein, the attribute information of the users comprises the behavioral information of the users, and whether the users' degrees of matching meet a preset threshold of matching is determined based on the behavioral information of the users.

17. A non-transitory computer-readable medium that stores a set of instructions that is executable by at least one processor of a server to cause the server to perform a method for processing and displaying review data, the method comprising:
acquiring the review data of a target object in accordance with an access trigger instruction of a target user;
determining whether an association relationship exists between the target user and a user corresponding to the review data in a pre-established multidimensional user relationship table;
acquiring the association relationship if the association relationship exists; and
displaying an identifier of the association relationship.

18. The medium of claim 17, wherein displaying the identifier of the association relationship comprises:
displaying, in a preset display area for displaying the review data, the identifier of the association relationship between the target user and the user corresponding to the review data.

19. The medium of claim 17, wherein the method further comprises:
prioritizing the display of review data associated with the identifier of the association relationship in a review interface for displaying the review data of the target object.

20. The medium of claim 17, wherein the multidimensional user relationship table is established by:
acquiring attribute information of users in an application system;
determining association relationships between the users whose degrees of matching meet a preset threshold of matching; and
establishing the multidimensional user relationship table based on the association relationships between the users and corresponding user identifiers.
